(19) United States
(12) Patent Application Publication
(10) Pub. No.: US 2025/0126690 A1
(43) Pub. Date: Apr. 17, 2025

(54) SAFETY FEATURES FOR LIGHT SOURCE SYSTEMS

(71) Applicant: ams Sensors Singapore Pte. Ltd., Singapore (SG)

(72) Inventors: Nicolino STASIO, Eindhoven (NL); Bassam HALLAL, Eindhoven (NL)

(21) Appl. No.: 18/568,178

(22) PCT Filed: Jun. 11, 2021
(86) PCT No.: PCT/SG2021/050336

§ 371 Date: Dec. 7, 2023

(30) Foreign Application Priority Data
Jun. 10, 2021 (GB) 2108327.4

(51) Int. Cl. H05B 47/105; G02B 3/00; H04N 13/254

(52) U.S. Cl. CPC H05B 47/105; G02B 3/0006; H04N 13/254

(57) ABSTRACT

A system includes a first light source; an optical element disposed on a face of a transparent substrate. The optical element is positioned to receive light from the first light source. The transparent substrate has edges that are beveled relative to the first face of the transparent substrate. The system includes a second light source positioned to illuminate the face of the transparent substrate at a position aligned with a first one of the beveled edges of the transparent substrate. The system includes a light detector positioned to receive light reflected from a second one of the beveled edges of the transparent substrate.

### BACKGROUND

Micro-lens arrays are arrays of small lenses that can be used in conjunction with light emitters, such as semiconductor-based light emitters, to form compact imaging devices. Compact imaging devices are used in vehicles, e.g., autonomous vehicles, and in mobile computing devices, such as mobile phones.

### SUMMARY

In an aspect, a system includes a first light source; an optical element disposed on a face of a transparent substrate. The optical element is positioned to receive light from the first light source. The transparent substrate has edges that are beveled relative to the first face of the transparent substrate. The system includes a second light source positioned to illuminate the face of the transparent substrate at a position aligned with a first one of the beveled edges of the transparent substrate. The system includes a light detector positioned to receive light reflected from a second one of the beveled edges of the transparent substrate.

Embodiments can include one or more of the following features.

An angle of the beveled edges is sufficient to enable total internal reflection within the transparent substrate of at least some of the light from the second light source.

An angle of the beveled edges is between about 30° and about 60° relative to the face of the transparent substrate.

The system includes a controller configured to control operation of the first light source. The controller is configured to control operation of the first light source based on an intensity of the light received by the light detector. The controller is configured to prevent operation of the first light source when the intensity of the received light exceeds a threshold intensity. The intensity of the received light exceeds the threshold intensity when the optical element is damaged or absent. The controller is configured to enable operation of the first light source when the intensity of the received light is below a threshold intensity. The intensity of the received light is below the threshold intensity when the optical element is intact.

The first face of the transparent substrate faces the first light source, the second light source, and the light detector.

The first light source, the second light source, and the light detector are disposed on a common substrate. The first light source, the second light source, and the light detector are disposed on a printed circuit board (PCB) substrate.

The first light source includes an array of first light sources. The optical element includes a micro-lens array (MLA).

The first light source includes a VCSEL.

The transparent substrate includes a glass substrate.

The system includes a shield layer disposed on a second face of the transparent substrate.

The system includes a filter configured to transmit light of a wavelength emitted by the first light source and to prevent transmission of light of a wavelength emitted by the second light source.

In an aspect, a vehicle includes a system having any one or more of the foregoing features.

In an aspect, a mobile computing device includes a system having any one or more of the foregoing features.

In an aspect, a method includes illuminating a position on a face of a transparent substrate with light from a second light source, the illuminated position being aligned with a first beveled edge of the transparent substrate, in which an optical element is disposed on the face of the transparent substrate; by a light detector, detecting light reflected from a second beveled edge of the transparent substrate; and controlling operation of a first light source based on an intensity of the detected light, the first light source being positioned to illuminate the optical element disposed on the face of the transparent substrate.

Embodiments can include one or more of the following features.

A condition of the optical element disposed on the first face of the transparent substrate affects the intensity of the detected light. When the optical element is damaged, the intensity of the detected light exceeds a threshold intensity. When the optical element is intact, the intensity of the detected light is below a threshold intensity.

Detecting light reflected from the second beveled edge of the transparent substrate includes detecting light from the second light source that is subject to total internal reflection within the transparent substrate.

Controlling operation of the first light source includes preventing operation of the first light source when the intensity of the detected light exceeds a threshold intensity.

Controlling operation of the first light source includes controlling the first light source to illuminate the optical element when the intensity of the detected light is below a threshold intensity.

In an aspect, a system includes a first light source; an optical element disposed on a face of a transparent substrate. The optical element is positioned to receive light from the first light source. The optical element includes a transmissive grating with a groove pitch sufficient to enable total internal reflection within the transparent substrate. The system includes a second light source positioned to illuminate a first side of the optical element on the transparent substrate; and a light detector positioned to receive light from a second side of the optical element.

In an embodiment, a pitch of the transmissive grating is sufficient to enable total internal reflection within the transparent substrate of at least some of the light from the second light source.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF DRAWINGS

FIG. 1 is a diagram of a light source system.

FIGS. 2A and 2B are diagrams of a light source system.

FIGS. 3A and 3B are diagrams of a light source system.

FIGS. 4A-4E are diagrams of configurations of a light source element.

FIG. 5 is a top view of a light source system.

FIGS. 6A-6E are diagrams of simulated light intensity for the configurations of FIGS. 4A-4E.

FIG. 7 is a plot of power for the configurations of FIGS. 4A-4E.

FIG. 8 is a diagram of a light source system.

FIG. 9 is a flow chart.

FIGS. 10A and 10B are diagrams of mobile computing devices.

FIG. 11 is a diagram of a vehicle.

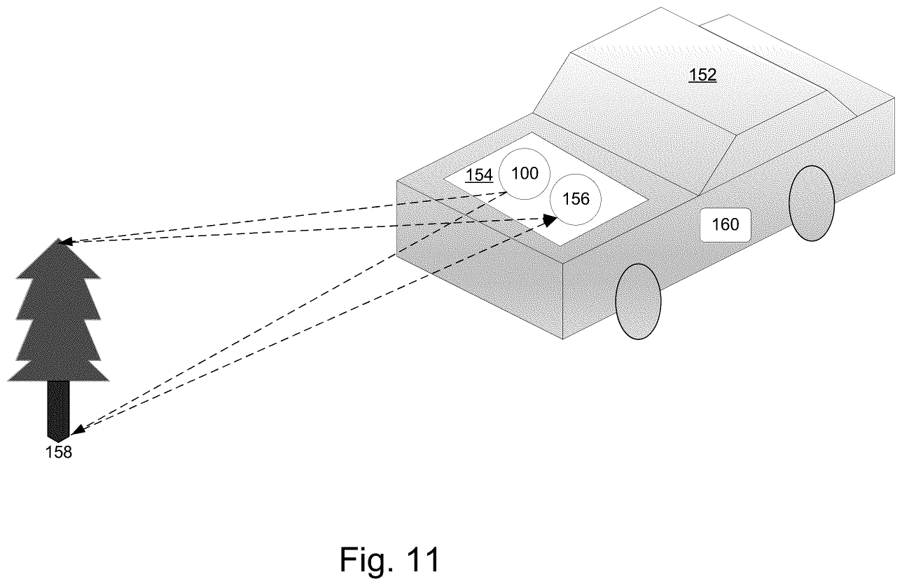

### DETAILED DESCRIPTION

We describe here safety features for a light source system. A first light source of the light source system emits light that is incident on an optical element, such as a microlens array. The light emitted by the first light source can be light of a wavelength or intensity that is potentially dangerous, e.g., to human eyesight. Damage to or absence of the optical element can sometimes all light from the first light source to be emitted to an exterior of the light source system, e.g., reaching the eye of a user. To mitigate the risk of light reaching an exterior of the light source system, the light source system includes a second light source and a photodetector that are arranged such that the intensity of light received by the photodetector is indicative of whether the optical element is intact. When the intensity of light received by the photodetector indicates that the optical element is not intact, e.g., damaged or absent, the operation of the first light source can be halted to reduce the risk of light escaping to an exterior of the light source system.

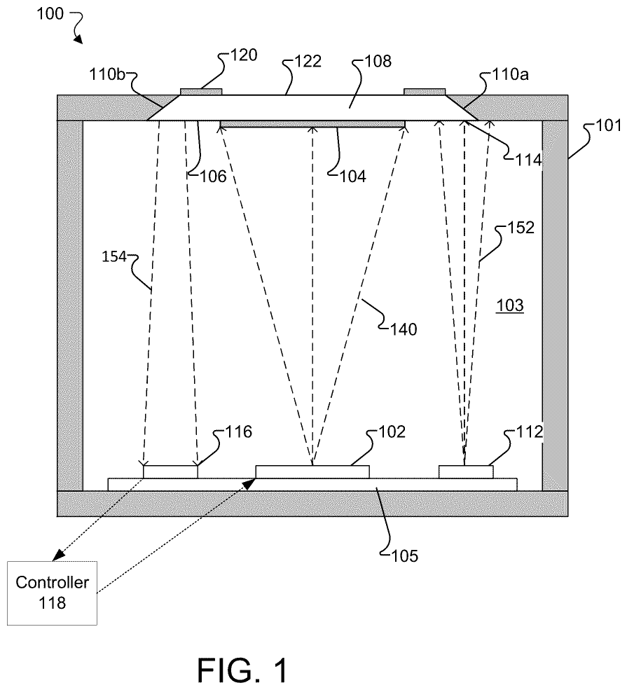

Referring to FIG. 1, a light source system 100 includes a housing 101 with a first light source 102, such as one or more vertical cavity surface emitting lasers (VCSELs), laser diodes, light emitting diodes, or another suitable light source, disposed in an interior 103 of the housing 101. In the example of FIG. 1, the light source 102 is disposed on and electrically connected to a substrate 105, such as a printed circuit board (PCB). In some examples, the light source 102 can be formed integrally with the substrate, e.g., the light source can be formed as part of an integrated circuit. In some examples, the integrated circuit can itself form a wall of the housing 101 such that the light source 102 is disposed in the wall of the housing. The light source system 100 can be a light source system for a mobile computing device, a light source system for a fully or partially autonomous vehicle, or can be used for other suitable applications.

An optical element 104 is disposed on a first face 106 of a transparent substrate 108, such as a glass substrate, and positioned to receive light 140 from the first light source 102. The transparent substrate 108 is sufficiently transparent such that at least some light of the wavelength emitted by the light source 102 is transmitted through the transparent substrate. The transparent substrate 108 forms one wall of the housing 101, with the first face 106 of the transparent substrate 108 facing an interior 103 of the housing 101. The optical element 104 is an element that can diffract, diffuse, or otherwise affect the light emitted by the light source 102, such that the light is coupled out of the housing 101. For instance, the optical element 104 can be one or more lenses, such as a microlens array (MLA).

The edges 110a, 110b of the transparent substrate 108 are beveled relative to the first face 106 of the transparent substrate 108. For instance, the edges 110a, 110b can be disposed at an angle of between about 30° and about 60°, e.g., about 30°, about 35°,about 40°, about 45°, about 50°, about 55°, or about 60°, relative to the plane of the first face 106. The angle of the beveled edges 110a, 110b is sufficient to enable total internal reflection into the transparent substrate 108 of at least some light incident on the beveled edges. In some examples, the transparent substrate 108 can have only a single edge, e.g., when the transparent substrate 108 is round or oval-shaped, and different regions of the single edge are referred to as the edges 110a, 110b.

A second light source 112 is disposed in the interior 103 of the housing 101 such that the second light source 112 faces the first face 106 of the transparent substrate 108. The second light source 112 can be, e.g., a VCSEL, a laser, a laser diode, a light emitting diode, or another suitable light source. The second light source 112 is positioned to emit light 152 that is incident on the first face 106 of the transparent substrate at a position 114 aligned with the beveled edge 110a. In the example of FIG. 1, the second light source 112 is disposed on the same substrate 105 as the first light source 102. In some examples, the second light source 112 is formed integrally with the first light source 102 in a single integrated circuit. In some examples, the integrated circuit can itself form a wall of the housing 101 such that the second light source 112 is disposed in the wall of the housing. In some examples, the second light source 112 is disposed on or formed in a substrate distinct from the substrate 105.

A light detector 116, such as one or more photodiodes, such as an array of photodiodes, is disposed in the interior 103 of the housing 101 and facing the first face 106 of the transparent substrate 108. The light detector 116 is positioned to receive light 154, if any, that is reflected downwards by the beveled edge 110b of the transparent substrate 108. In the example of FIG. 1, the light detector 116 is disposed on the same substrate 105 as the first light source 102. In some examples, the light detector 116 is formed integrally with the first light source 102 in a single integrated circuit. In some examples, the integrated circuit can itself form a wall of the housing 101 such that the light detector 116 is disposed in the wall of the housing. In some examples, the light detector 116 is disposed on or formed in a substrate distinct from the substrate 105.

Signals indicative of light detected by the light detector 116 are sent to a controller 118. The controller 118 can control operation of the first light source 102 based at least in part on the signals from the light detector 116.

A shield layer 120 is disposed on portions of a second face 122 of the transparent substrate 108, such as on portions that are not aligned with the optical element 104 or on portions that are aligned with the second light source 112. The shield layer 120 is formed of a material that is not transparent to light of the wavelength emitted by the second light source 112. A filter (not shown) can be disposed outside of the housing and facing the second face 122 of the transparent substrate 108. The filter can be, e.g., a notch filter, a band pass filter, or another type of filter that is configured to transmit light of the wavelength emitted by the first light source 102 and to prevent transmission of light of the wavelength emitted by the second light source 112. In some examples, the light source system 100 includes only one of the shield layer 120 and the filter. For instance, when the first and second light sources 102, 112 emit light of the same wavelength, the light source system 100 may not include a filter. In some examples, the light source system 100 includes both the shield layer 120 and the filter.

The light emitted by the first light source 102 can be light of a wavelength or intensity that that is potentially dangerous, e.g., to human eyesight. Damage to or absence of the optical element 104 can sometimes allow light from the light source 102 to be emitted to an exterior of the light source system 100, e.g., reaching the eye of a user. The second light source 112 and the light detector 116 provide safety functionality to the light source system 100. When a signal from the light detector 116 indicates that the optical element 104 may not be intact, e.g., may be damaged or absent, the operation of the first light source 102 can be halted, thereby mitigating the risk of emission of light from the light source 102 to the exterior of the light source system.

More particularly, when the optical element 104 is intact (e.g., present and undamaged), light from the second light source 112 is coupled out of the housing by the optical element 104, and little to no light reaches the light detector 116. When the optical element 104 is not intact (e.g., absent or damaged), at least some of the light from the second light source 112 reaches the light detector 116. Detection of light by the light detector 116 can thus be a proxy for the state of the optical element 104. For instance, an intensity of light detected by the light detector 116 exceeding a threshold can be an indication that the optical element 104 is not intact, and the controller 118 can stop operation of the first light source 102 to prevent or mitigate potential damage that could arise due to a not intact optical element 104.

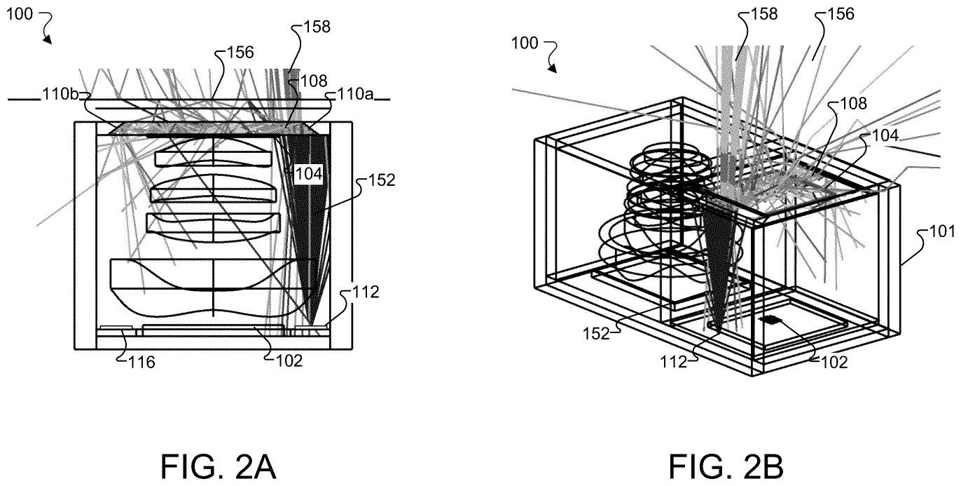

FIGS. 2A and 2B are side and perspective views, respectively, of the light source system 100 with an intact optical element 102. The light 152 from the second light source is incident on the position 114 that is aligned with the beveled edge 110a of the transparent substrate 108. The beveled edge 110a is angled to reflect a first portion of the light into an interior of the transparent substrate 108, and a second portion of the light is transmitted through the transparent substrate 108 as stray light 158. The light inside the transparent substrate 108 is incident on the optical element 104, which couples the light out of the transparent substrate 108 and out of the housing 101 as outgoing light 156. Little to no light reaches the opposite beveled edge 110b of the transparent substrate 108 or the light detector 116. When the light source system 100 includes a shield layer or a filter, the shield layer or filter can prevent the second portion 204 of the light from exiting the housing 101.

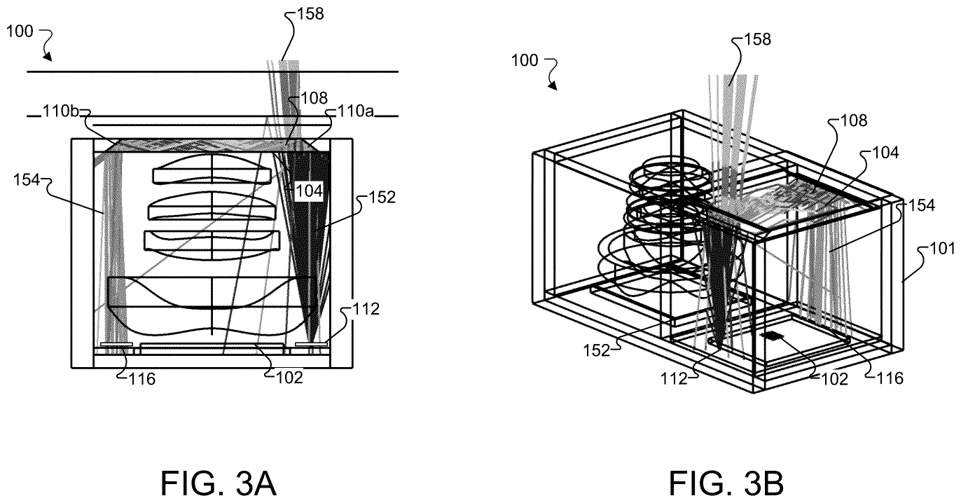

FIGS. 3A and 3B are side and perspective views, respectively, of the light source system 100 when the optical element 104 is not present. Light 152 from the second light source 112 is incident on the position 114 that is aligned with the beveled edge 110a of the transparent substrate 108. The beveled edge 110a reflects a first portion of the light into the interior of the transparent substrate 108, and a second portion of the light is transmitted through the transparent substrate 108 as stray light 158. Without the optical element disposed on the transparent substrate 108, the first portion of the light propagates along the interior of the transparent substrate 108, e.g., undergoing total internal reflection by the first and second faces 106, 122 of the transparent substrate 108.

When the light in the interior of the transparent substrate 108 reaches the opposite beveled edge 110b of the transparent substrate 108, the beveled edge 110b reflects light 154 downward, e.g., back into the interior of the housing 101. The light reflected back into the interior of the housing by the beveled edge 110b is sometimes referred to as returned light 154. The returned light 154 is incident on the light detector 116.

As can be seen from FIGS. 2A-2B and 3A-3B, the intensity of light detected by the light detector 116 is higher when the optical element 104 is not intact than when the optical element 102 is intact. In particular, the light detector 116 detects the returned light 154 (FIGS. 3A-3B) when the optical element 104 is not intact, and detects little to no light when the optical element 104 is intact.

A signal indicative of the intensity of the light detected by the light detector 116 can be provided to the controller. When the intensity of the detected light exceeds a threshold, the controller can stop operation of the first light source 102 or can prevent the first light source 102 from initiating operation. The threshold can be high enough to account for noise, e.g., for stray light reflected within the interior of the housing 101 but low enough to recognize that any light beyond a background level of noise has arrived at the light detector 116 because of an optical element 104 that is not intact. The threshold can be set to provide a margin of safety, e.g., such that any intensity of light detected beyond a background level of noise exceeds the threshold.

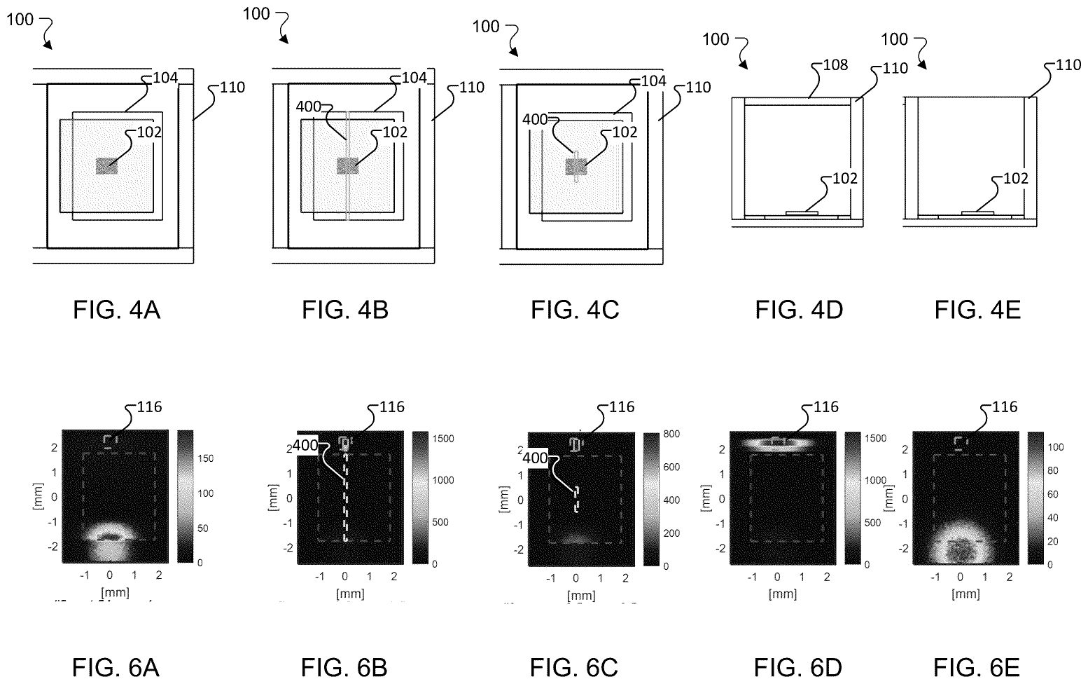

Simulations of the distribution of light intensity in the light source system 100 were performed for various configurations of the optical element 104, such as various configurations of damage to the optical element 104. FIGS. 4-6 relate to these simulations.

FIGS. 4A-4C depict top views of the light source system 100 with example configurations for the optical element 104. In FIG. 4A, the optical element (e.g., the optical element 104 of FIG. 1) is intact. In FIGS. 4B and 4C, the optical element is damaged, with the configuration of the damage being indicated by a damage element 400. FIG. 4D depicts a side view of the light source system 100 with no optical element on the transparent substrate 108. FIG. 4E depicts a side view of a light source system with no transparent substrate, such that the top wall of the housing 101 is open.

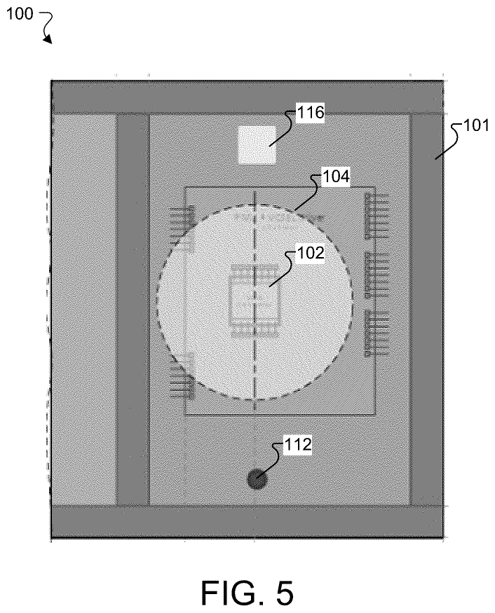

In simulations of the distribution of the light intensity for each of the example configurations of FIGS. 4A-4E, the light source system 100 is oriented as shown in FIG. 5, with the second light source 112 being located towards the bottom of the depiction and the light detector 116 being located towards the top of the depiction. Simulation results that indicate light intensity towards the top of the depiction thus indicate the presence of returned light (e.g., the returned light 154 of FIG. 3) that would be detected by the light detector 116.

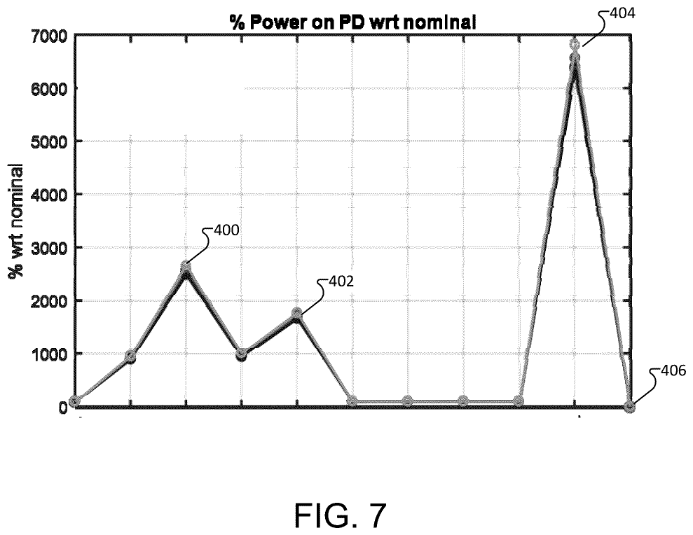

FIGS. 6A-6E show the simulated distribution of light intensity for each of the example configurations of FIGS. 4A-4E. FIG. 6A, corresponding to the configuration of FIG. 4A in which the optical element is intact, shows light intensity towards the bottom of the depiction, e.g., aligned with the second light source. This result indicates that little to no light is received by the light detector 116 (indicated in dashed lines) when the optical element is intact. FIGS. 6B and 6C, corresponding to the configurations of FIGS. 4B and 4C in which the optical element is damaged, each shows a low level of light intensity towards the top of the depiction, e.g., aligned with the light detector 116. These results indicate that light, e.g., of an intensity beyond a background noise level, is received by the light detector when the optical element is damaged. FIG. 6D, corresponding to the configuration of FIG. 4D in which the optical element is not present, shows a high level of light intensity towards the top of the depiction, e.g., aligned with the light detector 116. The difference in light intensity aligned with the light detector 116 for the examples of a damaged optical element (FIGS. 4B and 4C) and the example of an absent optical element (FIG. 4D) indicate that when the optical element is damaged, at least some light may still be coupled out of the housing by the optical element, e.g., by undamaged portions of the optical element. FIG. 6E, corresponding to the configuration of FIG. 4E in which the transparent substrate is not present, shows light intensity only towards the bottom of the depiction, e.g., aligned with the second light source. The results of FIG. 6E are consistent with the understanding that light arrives at the light detector 116 by way of transmission through the interior of the transparent substrate, e.g., by total internal reflection within the transparent substrate.

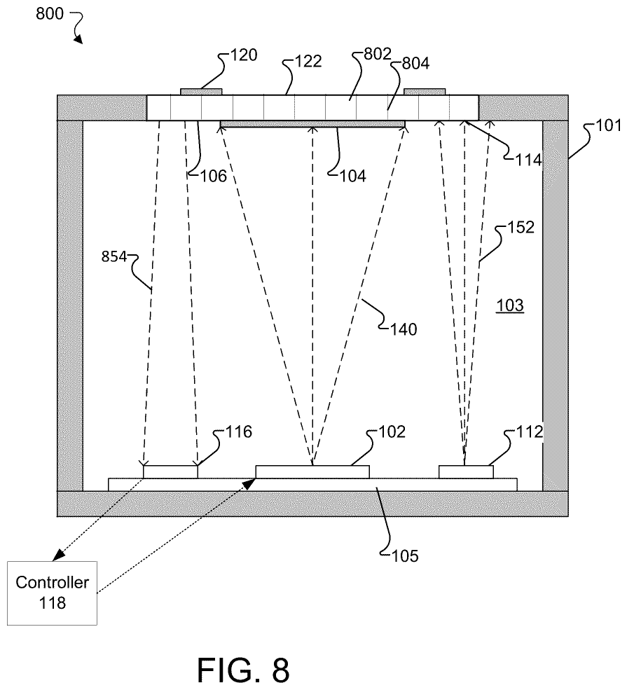

FIG. 7 is a plot of the relative power simulated at the light detector for each of the configurations of FIGS. 4B-4E relative to the intact configuration of FIG. 4A. Points 400 and 402, corresponding to the configurations of FIGS. 4B and 4C, respectively, demonstrate that significantly more power is incident on the light detector when the optical element is damaged. When the optical element is absent entirely, the power incident on the light detector is still higher, as shown at point 404, corresponding to the configuration of FIG. 4D. Without the transparent substrate, such as in the configuration of FIG. 4E, no power is incident on the optical detector, as shown at point 406. The result at point 406 is consistent with the model that light arrives at the light detector by way of transmission through the interior of the transparent substrate.

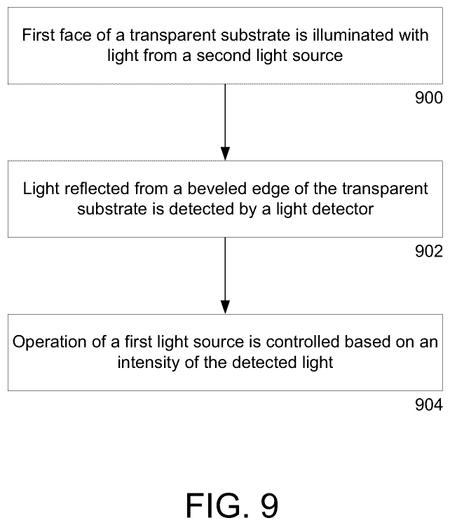

Referring to FIG. 8, a light source system 800 can include a transmissive grating 802 formed on the transparent substrate 108. The transmissive grating 802 can have a pitch (e.g., a pitch of grooves 804 of the transmissive grating) sufficient to enable total internal reflection of at least some of the light within the transparent substrate. Light 152 from the second light source 112 is incident on a first side of the transmissive grating 802, and the light detector 116 is positioned to receive light 854, if any, that undergoes total internal reflection and is reflected downwards by the transmissive grating 802.

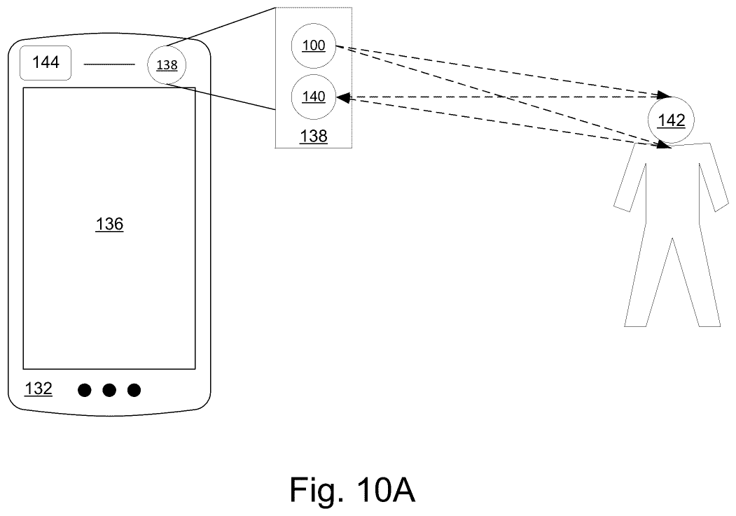

Referring to FIG. 9, in an example method of operation of a light source system, a position on a first face of a transparent substrate is illuminated with light from a second light source (900). The illuminated position is aligned with a first beveled edge of the transparent substrate. An optical element, such as an MLA, is disposed on the first face of the transparent substrate;

Light reflected from a second beveled edge of the transparent substrate is detected by a light detector (902). When the optical element is intact, little to no light reaches the light detector, because light from the second light source is coupled out of the housing of the light source system by the optical element. However, when the optical element is not intact, light propagates through the interior of the transparent substrate and is reflected by the second beveled edge of the transparent substrate onto the light detector.

Operation of a first light source is controlled based on an intensity of the detected light (904). The first light source is positioned to illuminate the optical element disposed on the first face of the transparent substrate. When the intensity of the detected light exceeds a threshold, e.g., a threshold indicative that the optical element is not intact, operation of the first light source can be stopped, or prevented from initiating. This control of the operation of the first light source helps to mitigate the risk of potentially dangerous light escaping the light source system, e.g., because of an optical element that is not intact.

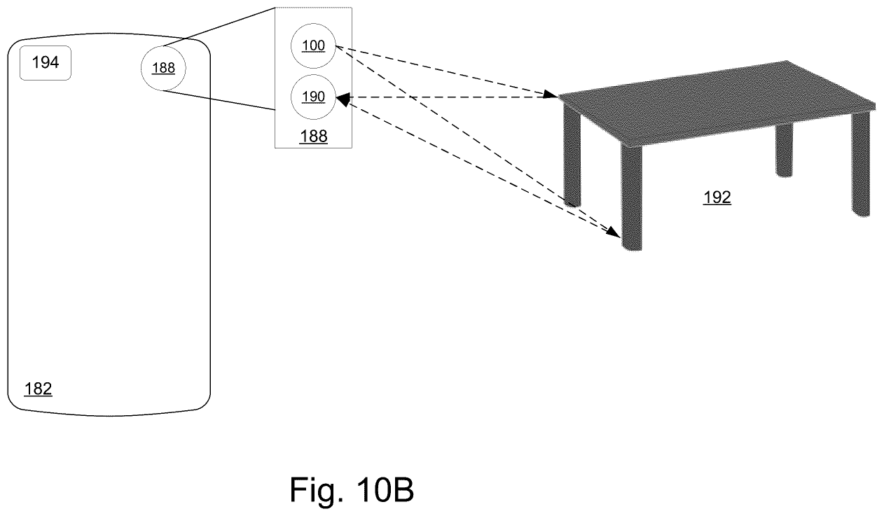

Referring to FIG. 10A, in some examples, a light source system 100 such as those described above can be mounted on or incorporated into a front side of a mobile computing device 132, such as a mobile phone, a tablet, or a wearable computing device. The front side of the mobile device 132 is the side of the device that includes a screen 136. The light source system 100 can be a flood illuminator. The light source system 100 can be incorporated into a front-side imaging system 138 that includes imaging components such as a sensor 140, e.g., a camera, mirror, or scanner. The front-side imaging system 138 including the light source system 100 can be used for 3-D imaging applications, e.g., for facial recognition. For instance, the light source system 100 can be used to illuminate a face 142 of a person, and the sensor 140 can be used to capture light reflected by the face 142. A signal based on the reflected light (e.g., a signal generated by a photodetector such as a photodiode) can be provided to one or more processors 144, e.g., in the mobile device 132 or remote, such as cloud-based processors. The one or more processors 134 can perform facial recognition processing based on the light reflected by the face 142.

Referring to FIG. 10B, in some examples, a light source system 100 such as those described above can be mounted on a back side of a mobile computing device 182. The back side is the side of the device opposite the front side, such as the side that does not include a screen. The light source system 100 can be a flood illuminator. The light source system 100 can be incorporated into a back-side imaging system 188 that includes imaging components such as a sensor 190, e.g., a camera, mirror, or scanner. The back-side imaging system 188 including the light source system 100 can be used, e.g., for 3-D imaging applications, e.g., for object recognition or for environmental mapping, such as mapping of a room. For instance, the light source system 100 can be used to illuminate an object 192 in a room or other environment, and the sensor 190 can be used to capture light reflected by the object 192. A signal based on the reflected light (e.g., a signal generated by a photodetector such as a photodiode) can be provided to one or more processors 194, e.g., in the mobile device 952 or remote, such as cloud-based processors. The one or more processors 194 can determine a 3-D shape of the object based on the reflected light. The determined 3-D shape can be used by the one or more processors 194 to perform object recognition processing, or can be used in combination with determined 3-D shapes of one or more other objects to develop a 3-D mapping of the room.

Referring to FIG. 1, in some examples, a light source system 100 such as those described above can be mounted on a vehicle 150, such as a partially-autonomous or fully-autonomous vehicle. The vehicle can be a land-based vehicle (as shown), such as a car or truck; an aerial vehicle, such as an unmanned aerial vehicle; or a water-based vehicle, such as a ship or submarine. The light source system 100 can be a flood illuminator. In the context of the partially-or fully-autonomous vehicle 150, the light source system 100 can form part of a remote imaging system 154, such as a LIDAR (Light Detection and Ranging) system, that includes imaging components such as a sensor 156, e.g., a camera, mirror, or scanner. The imaging system 154 including the light source system 100 can be used, e.g., for three-dimensional (3-D) mapping of the environment of the vehicle 100. For instance, the light source system 100 can be used to illuminate an object 158, e.g., an object in or near a roadway on which the vehicle 152 is traveling, and the sensor 156 can be used to capture light reflected by the illuminated object 158. A signal based on the reflected light (e.g., a signal generated by a photodetector such as a photodiode) can be provided to a computing device 160, e.g., including one or more processors, that determines a 3-D shape of the object based on the reflected light. By determining the 3-D shapes of various objects, a mapping of an environment of the vehicle can be determined and used to control the partially-or fully-autonomous operation of the vehicle 152.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A system comprising:
a first light source;
an optical element disposed on a face of a transparent substrate, the optical element being positioned to receive light from the first light source, the transparent substrate having edges that are beveled relative to the first face of the transparent substrate;
a second light source positioned to illuminate the face of the transparent substrate at a position aligned with a first one of the beveled edges of the transparent substrate; and
a light detector positioned to receive light reflected from a second one of the beveled edges of the transparent substrate.

2. The system of claim 1, in which an angle of the beveled edges is sufficient to enable total internal reflection within the transparent substrate of at least some of the light from the second light source; and/or
in which an angle of the beveled edges is between about 30° and about 60° relative to the face of the transparent substrate.

3. (canceled).

4. The system of claim 1, comprising a controller configured to control operation of the first light source.

5. The system of claim 4, in which the controller is configured to control operation of the first light source based on an intensity of the light received by the light detector.

6. The system of claim 5, in which the controller is configured to prevent operation of the first light source when the intensity of the received light exceeds a threshold intensity; and/or
in which the controller is configured to enable operation of the first light source when the intensity of the received light is below a threshold intensity.

7. The system of claim 6, in which the intensity of the received light exceeds the threshold intensity when the optical element is damaged or absent; and/or
in which the intensity of the received light is below the threshold intensity when the optical element is intact.

8. (canceled).

9. (canceled).

10. The system of claim 1, in which the first face of the transparent substrate faces the first light source, the second light source, and the light detector.

11. The system of claim 1, in which the first light source, the second light source, and the light detector are disposed on a common substrate;
in which the first light source, the second light source, and the light detector are disposed on a printed circuit board (PCB) substrate.

12. (canceled).

13. The system of claim 1, in which the first light source comprises an array of first light sources;
in which the optical element comprises a micro-lens array (MLA).

14. (canceled).

15. The system of claim 1, in which the first light source comprises a VCSEL; and/or
in which the transparent substrate comprises a glass substrate.

16. (canceled).

17. The system of claim 1, comprising a shield layer disposed on a second face of the transparent substrate; and/or
comprising a filter configured to transmit light of a wavelength emitted by the first light source and to prevent transmission of light of a wavelength emitted by the second light source.

18. (canceled).

19. A vehicle comprising the system of claim 1.

20. A mobile computing device comprising the system of claim 1.

21. A method comprising:
illuminating a position on a face of a transparent substrate with light from a second light source, the illuminated position being aligned with a first beveled edge of the transparent substrate, in which an optical element is disposed on the face of the transparent substrate;
by a light detector, detecting light reflected from a second beveled edge of the transparent substrate; and
controlling operation of a first light source based on an intensity of the detected light, the first light source being positioned to illuminate the optical element disposed on the face of the transparent substrate.

22. The method of claim 21, in which a condition of the optical element disposed on the first face of the transparent substrate affects the intensity of the detected light.

23. The method of claim 22, in which when the optical element is damaged, the intensity of the detected light exceeds a threshold intensity; and/or
in which when the optical element is intact, the intensity of the detected light is below a threshold intensity.

24. (canceled).

25. The method of claim 21, in which detecting light reflected from the second beveled edge of the transparent substrate comprises detecting light from the second light source that is subject to total internal reflection within the transparent substrate.

26. The method of claim 21, in which controlling operation of the first light source comprises preventing operation of the first light source when the intensity of the detected light exceeds a threshold intensity; and/or
in which controlling operation of the first light source comprises controlling the first light source to illuminate the optical element when the intensity of the detected light is below a threshold intensity.

27. (canceled).

28. A system comprising:
a first light source;
an optical element disposed on a face of a transparent substrate, the optical element being positioned to receive light from the first light source, optical element comprising a transmissive grating with a groove pitch sufficient to enable total internal reflection within the transparent substrate;
a second light source positioned to illuminate a first side of the optical element on the transparent substrate; and
a light detector positioned to receive light from a second side of the optical element.

29. The system of claim 28, in which a pitch of the transmissive grating is sufficient to enable total internal reflection within the transparent substrate of at least some of the light from the second light source.
